(19) United States
(12) Patent Application Publication
(10) Pub. No.: US 2020/0302054 A1
(43) Pub. Date: Sep. 24, 2020

(54) Method for detecting physical intrusion attack in industrial control system based on analysis of signals on serial communication bus

(71) Applicant: XI'AN JIAOTONG UNIVERSITY, Xi'an, Shaanxi (CN)

(72) Inventors: Ting Liu, Xi'an, Shaanxi (CN); Pengfei Liu, Xi'an, Shaanxi (CN); Jiazhou Wang, Xi'an, Shaanxi (CN); Yadong Zhou, Xi'an, Shaanxi (CN)

(21) Appl. No.: 16/755,163

(22) PCT Filed: Jan. 22, 2019
(86) PCT No.: PCT/CN2018/120178

§ 371 Date: Apr. 10, 2020

(30) Foreign Application Priority Data
Apr. 20, 2018 (CN) 201810361229.6

(51) Int. Cl. G06F 21/55; G06F 13/42; H04L 12/40

(52) U.S. Cl. CPC G06F 21/552; G06F 21/554; H04L 2012/40228; H04L 12/40013; G06F 2221/033; G06F 13/4282

(57) ABSTRACT

A method for detecting physical intrusion attack in an industrial control system based on analysis of signals on serial communication bus is provided. This method comprises of actively sending a detection signal to communication bus via a bus controller in a serial communication bus network, sampling and analyzing signals on the communication bus by a monitoring device, performing differential comparison with a standard signal stored in the monitoring device database, detecting an intrusion signal in difference signal based on noise reduction technology and weak signal detection technology, and according to a detection result of the intrusion signal caused by an external device to effectively determine whether there is an external malicious device in the system, and whether the system is subjected to a physical intrusion attack.

### CROSS REFERENCE OF RELATED APPLICATION

This is a U.S. National Stage under 35 U.S.C. 371 of the International Application PCT/CN2018/120178, filed Jan. 22, 2019, which claims priority under 35 U.S.C. 119(a-d) to CN 201810361229.6, filed Apr. 20, 2018.

### BACKGROUND OF THE PRESENT INVENTION

### Field of Invention

The present invention relates to the field of attack detection technology in industrial control system, and particularly relates to a method for detecting physical intrusion attack in industrial control system based on analysis of signals on serial communication bus.

### Description of Related Arts

The industrial control system is an automatic control system applied in the fields of electric power, industrial production, transportation, processing, manufacturing and etc. The system mainly relies on the control center to monitor the operation status of equipments in networks at all levels, and analyze the measurement data collected from equipments, and further to carry out physical measures to maintain the stability and safety. With the development of communication technology and the integration of information networks, the cascading relationship of systems in various fields has made the whole of industrial control system increasingly large and complex. In the process of transition from centralized control to distributed control, although the overall control efficiency and response speed of industrial control system are improved, the ability of the control center to supervise the safety and security of the bus-level network at the bottom or edge is reduced. Especially in unattended locations, the safety of the equipment itself cannot be guaranteed.

In 2017, Dr. Staggs and his team from the University of Tulsa in the United States disclosed a “Windshark” attack on wind farms, which caused damage to the turbines and controllers in wind farm by breaking the server cabinet and physical connecting into the communication equipment to realize the control and malicious operation of the wind farm internal system. It can be seen from this case that most of the current industrial control systems are not well protected against physical intrusion attacks, and the attacker can easily access the communication devices in the serial communication bus network and utilize the device to tamper with the communication signal on the communication bus, or send forging malicious instructions or data to the communication bus, which is a great threat to the industrial control system because it could cause abnormalities in the operation of the devices in the serial communication bus network, and even disturbing the stable operation of the system.

In the traditional industrial control system, for common network intrusion attacks, there have been many researches on security defense methods, such as communication encryption to ensure information security, traffic monitoring to prevent malicious data injection, and intrusion detection system to identify malicious attack behavior, etc. However, the above method is difficult to apply against the physical intrusion attacks in industrial control system. On the one hand, the serial bus communication network lacks of safety protection. After the physical intrusion, there is no effective way to detect whether there is an external device in the system, and there is no corresponding identity authentication mechanism in communication. On the other hand, in the serial communication bus network, due to the real-time requirements of industrial equipment communication and the weak computing power of the device itself, it is difficult to rely on well-designed encryption algorithms to ensure reliable information in the serial communication bus protocol, and these protocols are open to the public at the beginning of design, which is easy for an attacker to use these protocols to intercept information or falsify instructions. The above two points all indicate that the serial communication bus network of the industrial control system has security risks of physical intrusion, and it is difficult to detect the external devices, which will have a great adverse effect on the stable operation of the industrial control system.

### SUMMARY OF THE PRESENT INVENTION

An object of the present invention is to provide a method for detecting physical intrusion attack in industrial control system based on analysis of signal on serial communication bus, which is used for preventing a physical intrusion attack threat that an industrial control system may face, and effectively solving the security problem that the traditional network intrusion prevention method cannot detect the malicious external devices in serial communication bus network

In order to achieve the above object, the present invention adopts technical solutions as follows.

A method for detecting physical intrusion attack in industrial control system based on analysis of signals on serial communication bus, comprises steps of: actively sending a detection signal to communication bus via a bus controller in a serial communication bus network, sampling and analyzing signals on the communication bus by a monitoring device, performing differential comparison with a standard signal stored in the monitoring device database, detecting an intrusion signal in difference signal based on noise reduction technology and weak signal detection technology, and according to a detection result of the intrusion signal caused by an external device, effectively determining whether there is an external malicious device in the system, and determining whether the system is subjected to a physical intrusion attack.

Furthermore, the method specifically comprises steps of:

S1: monitoring a service condition of serial communication bus in the industrial control system according to a set time period by the bus controller;

if the communication bus is in an idle state, sending a detection signal once by the bus controller;

if the communication bus is in a data transmission state, continuing to monitor and wait until the communication bus is in an idle state, then sending the detection signal once by the bus controller;

S2: performing sampling and protocol parsing on all received communication signals on the serial communication bus by the monitoring device deployed in the network;

S3: analyzing signals after parsing and determining whether to start detecting physical intrusion attack in the industrial control system;

S4: comparing signal data received with standard signal data in the database of monitoring device to obtain a difference signal therebetween;

S5: detecting the intrusion signal on the difference signal; if the intrusion signal is detected in the difference signal, judging that the serial communication bus network of the industrial control system is subjected to the physical intrusion attack and continuing to execute S6; if no intrusion signal is detected in the difference signal, judging that the serial communication bus network of the industrial control system is not subjected to the physical intrusion attack and continuing to monitor the bus to receive a next communication signal;

S6: according to a detection result of the intrusion signal, if the serial communication bus network of the industrial communication system is subjected to physical intrusion attack, reporting the detection result to the bus controller in the serial communication bus network, and making a quick judgment and an emergency response on the physical intrusion attack by the bus controller.

Preferably, in the step S1, the detection signal is set according to a protocol specification of the serial communication bus, and the detection signal is different from all normal communication signals in the digital sequence, and the detection signal is only capable of being identified and analyzed by a corresponding monitoring device in the serial communication bus network, and the other devices are not capable of responding to detection signals.

Preferably, the step S2 specifically comprises steps of: according to types of the serial communication bus in the industrial control system, performing protocol parsing on communication signals by adopting one corresponding protocol such as Modbus, CANBus, P-Net, ProfiBus, WorldFIP, ControlNet, FF or HART to obtain a digital signal sequence.

Preferably, the step S3 specifically comprises steps of:

S301: performing consistency detection on the digital signal sequence parsed in the step S2 and the digital sequence of the detection signal, if the signal received is the detection signal, starting detecting the physical intrusion attack in the industrial control system, and performing a step S302; if the signal received is not the detection signal, then making no response, and continuing monitoring the bus to receive the next communication signal;

S302: according to a consistency detection result between the signal received and the detection signal, continuing to determine whether the monitoring device receives the detection signal for a first time; if the signal database of the monitoring device is empty, storing the received signal data in the local database, and considering the signal is a standard signal under normal conditions of the system; if the signal data is already stored in the signal database of the monitoring device, continuing performing the step S4.

Preferably, in the step S5, the intrusion signal is a definite signal added to an original detection signal sent by the bus controller caused by the physical intrusion attack, and the intrusion signal has the same period with the detection signal.

Preferably, the step S5 specifically comprises steps of:

S501: performing noise reduction processing on the difference signal data obtained in step S4;

S502: by using weak signal detection technology, detecting and determining whether the intrusion signal exists in the difference signal according to a result of the weak signal detection.

Furthermore, the step further comprises a step of: alerting to a primary station after receiving the detection signal of the physical intrusion attack by the bus controller.

Compared with the conventional arts, the present invention has the following beneficial effects:

The invention provides a method for detecting physical intrusion attack in industrial control system based on analysis of signals on serial communication bus, in which, the serial communication bus signals are sampled and analyzed by monitoring device, and the intrusion signal is detected with noise reduction technology and weak signal detection technology after being compared with the standard signals stored in the database. According to the detection result of the intrusion signal, it can quickly and effectively determine whether there is an external malicious device in the system, and determine whether the system is security against the physical intrusion attack, which solves the security technical problem that the external devices can not be detected effectively by network defense method in serial communication bus network of industrial control system.

In addition, the present invention utilizes the bus controller in serial communication bus network of industrial control system to transmit a detection signal, and then uses the monitoring device deployed in the network to perform sampling, differential comparison analysis, and signal detection, thereby it will not increase the cost of modification on original devices and will not change the connection structure of the original communication network.

The detection signal of the present invention is set according to the serial communication bus type and protocol of the industrial control system, and the detection signal is different from all normal communication signals in the digital sequence, and the detection signal is transmitted only when the serial communication bus is idle. It will not affect the normal communication between communication devices, and will not disturb the system by abnormal responses from other devices receiving detection signals.

In the invention, after receiving the signal, the monitoring device first performs the consistency comparison between the received signal sequence and the detection signal sequence, and continues to monitor when two signal sequence are inconsistent, besides, the monitoring device keeps monitoring state after the intrusion signal is not found according to the intrusion detection result. The above measures are to further reduce the time and resources of detecting the physical intrusion attack in serial communication bus in industrial control system and improve the rapidity and efficiency of detection method.

### BRIEF DESCRIPTION OF THE DRAWINGS

In order to more clearly illustrate the embodiments of the present invention or the current technical solutions, the drawings described in the preferred embodiments or the current technical solutions will be briefly described below.

FIG. 1 is a structure of RS485 bus in industrial control system according to a preferred embodiment of the present invention.

FIG. 2 is an equivalent model of RS485 bus in the industrial control system according to the preferred embodiment of the present invention.

FIG. 3 is a steady state model of RS485 bus in the industrial control system according to the preferred embodiment of the present invention.

FIG. 4 is a noise reduction result of digital averaging method from a difference signal by the monitoring device; wherein, FIG. 4 (a) is a difference signal before digital averaging processing, and FIG. 4 (b) is a difference signal after digital averaging processing.

FIG. 5 is a cross-correlation detection result from the difference signal by the monitoring device; wherein FIG. 5 (a) is the detection result with the intrusion signal, and FIG. 5 (b) is the detection result without intrusion signal.

FIG. 6 is a flow chart according to the preferred embodiment of the present invention.

### DETAILED DESCRIPTION OF THE PREFERRED EMBODIMENT

The preferred embodiments of the present invention provide a method for detecting physical intrusion attack in industrial control system based on analysis of signals on serial communication bus, which solves the safety and security technology problem that the external devices can not be effectively detected by network defense methods in the serial communication bus network in the industrial control system.

The technical solutions of the embodiments of the present invention will be clearly and completely described in conjunction with the drawings in the embodiments of the present invention. The present invention provides a method for detecting physical intrusion attack which can deal with an attack scenario, that is, in the industrial control system RS485 bus network, the attacker implants an external device in the system through physical invasion, and uses the device to obtain communication information and forge control instructions to endanger the system security and stability. For specific analysis, see the following embodiments.

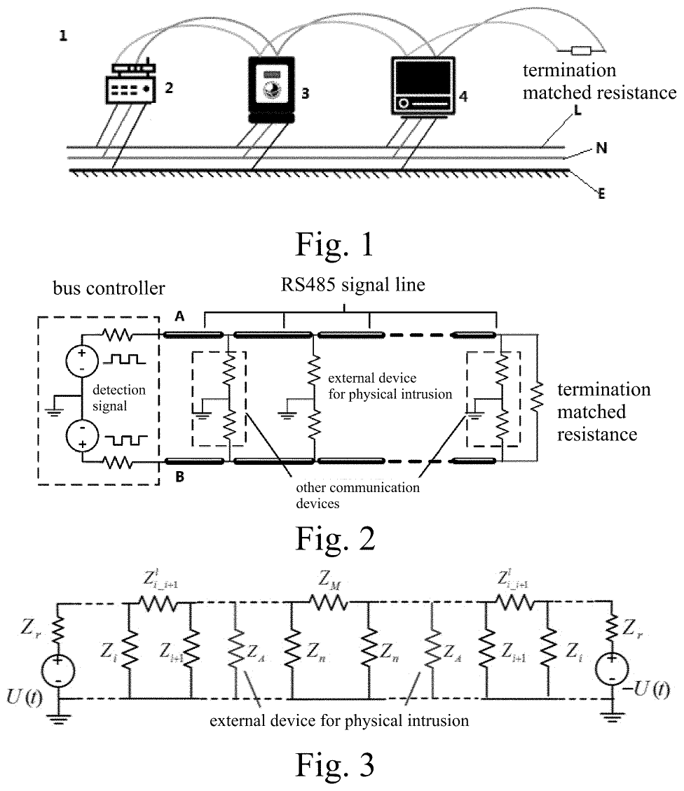

FIG. 1 is a network structure of RS485 communication bus 1 in an industrial control system, which is mainly composed of a bus controller 2 and various communication devices such as a measurement device 3 and a control device 4, all of which are connected in a daisy-chain structure. All devices are connected to the live line L, the neutral line N and the ground line E of the power transmission line. Among all devices, only the controller has the right to send signals to the bus. According to the communication mode of RS485, the signal phases of two signals on lines are opposite, and the difference between the two signals is taken as the receiving signal by other devices. The devices choose to filter or respond according to the address in the difference signal after the protocol parsing.

FIG. 2 is an equivalent model of RS485 communication bus in the industrial control system. In this model, the controller is equivalent to two synchronous opposite signal sources. The other communication devices are regarded as input impedance with fixed-value, and the matched resistance is connected at the ends of the transmission lines to eliminate the reflection. When the system is attacked by physical intrusion, an external device that the attacker accesses in the original system is also considered as the input impedance in the model. In order to better analyze the stable signal, the steady state model of RS485 communication bus is shown in FIG. 3.

In the steady state model, the transmission line is equivalent to impedance which is only related to the resistance of the transmission line itself and its inherent parameters such as length, thickness and material, different from the characteristic impedance. As shown in FIG. 3, Zᵢ=(i=1, 2, . . . , n) represents the input impedance of ith device, Z_{M} is the termination matched resistance, Zᵣ is the internal resistance of the signal source, and Z_{i_i+1}^{l}(i=1, 2, . . . , n) represents the equivalent impedance of the transmission line between the ith device and the (i+1)th device in the steady state of the system, meanwhile, it is regarded the first device when i=0. The input impedance of an external device accessed by the attacker through the physical intrusion attack into the system is recorded as Z_{A}.

Therefore, in the case that there is no external device accessed in the system, the following two iterative processes are required to calculate the system impedance of the steady state model in FIG. 3:

1) Assign the initial value r₀=Zᵣ, and calculate the impedance after Z_{M}:

$${r}_{i} = \frac{{Z}_{i} \cdot ( {Z}_{i - 1 \_ i}^{l} + {r}_{i - 1} )}{{Z}_{i} + {Z}_{i - 1 \_ i}^{l} + {r}_{i - 1}} , i = 1 , 2 , … , n$$

2) Calculate the impedance before Z_{M} with the above iterative result rₙ:

$${r}_{n + 1} = \frac{{Z}_{n} \cdot ( {Z}_{0} + {r}_{n} )}{{Z}_{n} + {Z}_{0} + {r}_{n}}$$

$${r}_{i} = \frac{{Z}_{2 n - i + 1} \cdot ( {Z}_{2 n - i + 1 \_ 2 n - i + 2}^{l} + {r}_{i - 1} )}{{Z}_{2 n - i + 1} + {Z}_{2 n - i + 1 \_ 2 n - i + 2}^{l} + {r}_{i - 1}} , i = 1 , 2 , … , 2 n$$

When an attacker accesses an external device into the system through physical intrusion attack, assuming that the access location of the external device is between the kth device and the (k+1)th device, the above two impedance iterative calculation will be changed:

1) While calculating rₖ to rₖ₊₁:

$${r}_{x} = \frac{{Z}_{A} \cdot ( η {Z}_{k \_ k + 1}^{l} + {r}_{k} )}{{Z}_{A} + η {Z}_{k \_ k + 1}^{l} + {r}_{k}} \\ {r}_{k + 1} = \frac{{Z}_{k + 1} \cdot [ ( 1 - η ) {Z}_{k \_ k + 1}^{l} + {r}_{x} ]}{{Z}_{k + 1} + ( 1 - η ) {Z}_{k \_ k + 1}^{l} + {r}_{x}}$$

2) While calculating r₂ₙ₋ₖ to r₂ₙ₋ₖ₊₁:

$${r}_{y} = \frac{{Z}_{A} \cdot [ ( 1 - η ) {Z}_{k \_ k + 1}^{l} + {r}_{2 n - k} ]}{{Z}_{A} + ( 1 - η ) {Z}_{k \_ k + 1}^{l} + {r}_{2 n - k}} \\ {r}_{2 n - k + 1} = \frac{{Z}_{k + 1} \cdot ( η {Z}_{k \_ k + 1}^{l} + {r}_{y} )}{{Z}_{k + 1} + η {Z}_{k \_ k + 1}^{l} + {r}_{y}}$$

For such an attack situation, combined with FIG. 3 and the derivation of the above system impedance, a method for detecting physical intrusion attack in an industrial control system based on analysis of signals on serial communication bus is specifically described, which includes the following steps:

When the system first uses the method for detecting physical intrusion attack of the present invention, the specific execution process and steps are as follows:

Step S1: The bus controller in the RS485 communication bus network monitors the bus usage state, and when detecting that the bus is in an idle state, sends a detection signal U(t) to the two RS485 signal lines, the detection signal is a square wave signal with a period of 200 μs and an amplitude of −5V to 5V;

Step S2: The monitoring device deployed in the RS485 communication bus network collects signals on the bus. According to the steady state model of FIG. 3, it is assumed that the device at the mth position in the system is a monitoring device, and then when the bus controller sends the detection signal U(t), the differential signal of two signals on transmission lines is:

V_{diff}(m,t)=2(ρₘ−μₘ)U(t)+ν(t)

Wherein ν(t) is the sum of the environment noise and the measurement noise, and ρₘ, ρₘ are the voltage signal partition coefficient at the mth monitoring device:

$${ρ}_{m} = \frac{{\prod }_{j = 1}^{m} {r}_{2 n - j + 1}}{( {r}_{2 n} + {Z}_{r} + {Z}_{0 \_ 1}^{l} ) {\prod }_{j = 2}^{m} ( {r}_{2 n - j + 1} + {Z}_{j - 1 \_ j}^{l} )} ;$$

$${μ}_{m} = {ρ}_{m} \cdot \frac{{\prod }_{j = m}^{n} {r}_{j}}{( {r}_{n} + {Z}_{M} ) {\prod }_{j = m}^{n - 1} ( {r}_{j} + {Z}_{j \_ j + 1}^{l} )} ;$$

Then the monitoring device will parse the signal according to the RS485 common protocol-ModBus protocol to obtain the corresponding digital signal sequence;

Step S3: The monitoring device analyzes and processes the parsed signal, and specifically includes the following steps:

Step S301: Perform consistency detection on the digital sequence of the received signal and the digital sequence of the detection signal. If the two sequence are inconsistent, this indicates that the received signal is not the detection signal and the monitoring device continues to maintain the monitoring state; If the two sequence are consistent, this indicates that the detection signal is received, and the process goes to step S302;

Step S302: The monitoring device determines whether the detection signal is received for the first time. After detecting the local signal database of the device, if there is no data in the database, it is determined that the detection signal at this time is a standard signal in the initial state of the system, and the standard signal will be stored in the signal database and the physical intrusion attack detection process will be ended.

When the system does not uses the method for detecting physical intrusion attack for the first time, the specific execution process and steps are as follows:

Step S1: When the RS485 bus is in an idle state, the bus controller sends a detection signal to the two signal lines of RS485 which is inversely processed according to the RS485 balanced transmission mode;

Step S2: The monitoring device collects the signals on the bus. According to the steady state model of FIG. 3, when the attacker accesses the external device through the physical intrusion attack, the detection signal collected by monitoring device becomes to:

V_{diff}′(m,t)=2(ρₘ′−μₘ′)U(t)+ω(t)

Wherein ω(t) is the sum of environment noise and measurement noise, and ρₘ′, μₘ′ become the following two cases:

1) If the (k+1)th device is before the mth device:

$${ρ}_{m}^{′} = {ρ}_{m} \cdot \frac{{r}_{y} ( {r}_{2 n - k} + {Z}_{k \_ k + 1}^{l} )}{( {r}_{y} + η {Z}_{k \_ k + 1}^{l} ) [ {r}_{2 n - k} + ( 1 - η ) {Z}_{k \_ k + 1}^{l} ]}$$

$${μ}_{m}^{′} = {μ}_{m} \cdot \frac{{r}_{x} ( {r}_{k} + {Z}_{k \_ k + 1}^{l} )}{[ {r}_{x} + ( 1 - η ) {Z}_{k \_ k + 1}^{l} ] ( {r}_{k} + η {Z}_{k \_ k + 1}^{l} )}$$

2) If the kth device is after the mth device:

$${ρ}_{m}^{′} = {ρ}_{m}$$

$${μ}_{m}^{′} = {μ}_{m} \cdot \frac{{r}_{y} ( {r}_{2 n - k} + {Z}_{k \_ k + 1}^{l} )}{( {r}_{y} + η {Z}_{k \_ k + 1}^{l} ) [ {r}_{2 n - k} + ( 1 - η ) {Z}_{k \_ k + 1}^{l} ]} \cdot \frac{{r}_{x} ( {r}_{k} + {Z}_{k \_ k + 1}^{l} )}{[ {r}_{x} + ( 1 - η ) {Z}_{k \_ k + 1}^{l} ] ( {r}_{k} + {ηZ}_{k \_ k + 1}^{l} )}$$

Then, the monitoring device parses the signal according to the RS485 common protocol-ModBus protocol, and obtains a corresponding digital signal sequence;

Step S3: The monitoring device analyzes and processes the parsed signal, and specifically includes the following steps:

Step S301: Perform consistency detection on the digital sequence of the received signal and the digital sequence of the detection signal. If the two sequence are inconsistent, this indicates that the signal is not a detection signal and the monitoring device continues to maintain the monitoring state; If the two sequence are consistent, this indicates that the detection signal is received, and the process goes to step S302;

Step S302: The monitoring device determines whether the detection signal is received for the first time. After detecting the local signal database of the device, since the standard signal is already stored in the database, the physical intrusion attack detection process is continued, and the process goes to step S4.

Step S4: differentially comparing the received detection signal data with standard signal data in the monitoring device signal database to obtain a difference signal between the two signals;

If the system is not attacked by physical intrusion, that means there is no external device, the result of the differential signal should be:

ΔV_{diff}(m,t)=ν(t)−ω(t)

If the system is attacked by physical intrusion, that means there is at least one external device, the result of the differential signal should be:

ΔV_{diff}(m,t)=δ(t)+ν(t)−ω(t)

δ(t)=2[(ρₘ−ρₘ′)−(μₘ−μₘ′]U(t)

Among them δ(t) is the intrusion signal caused by the external device;

Step S5: detecting intrusion signal on the difference signal, wherein the detection processing and the step specifically include:

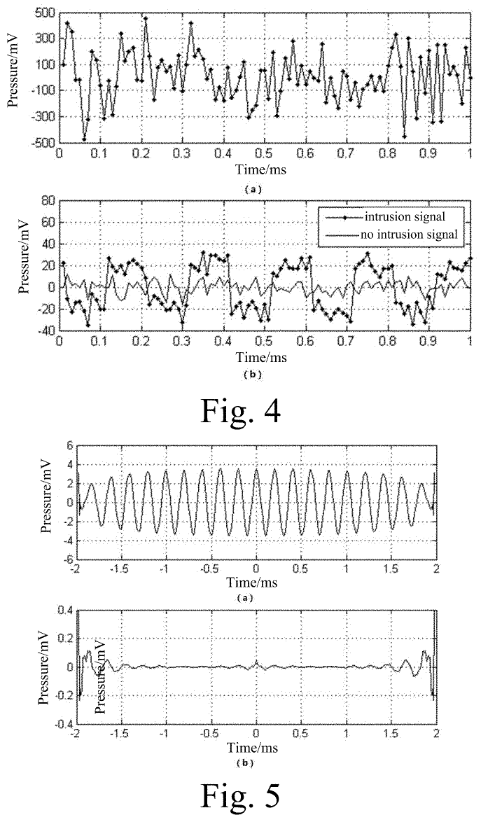

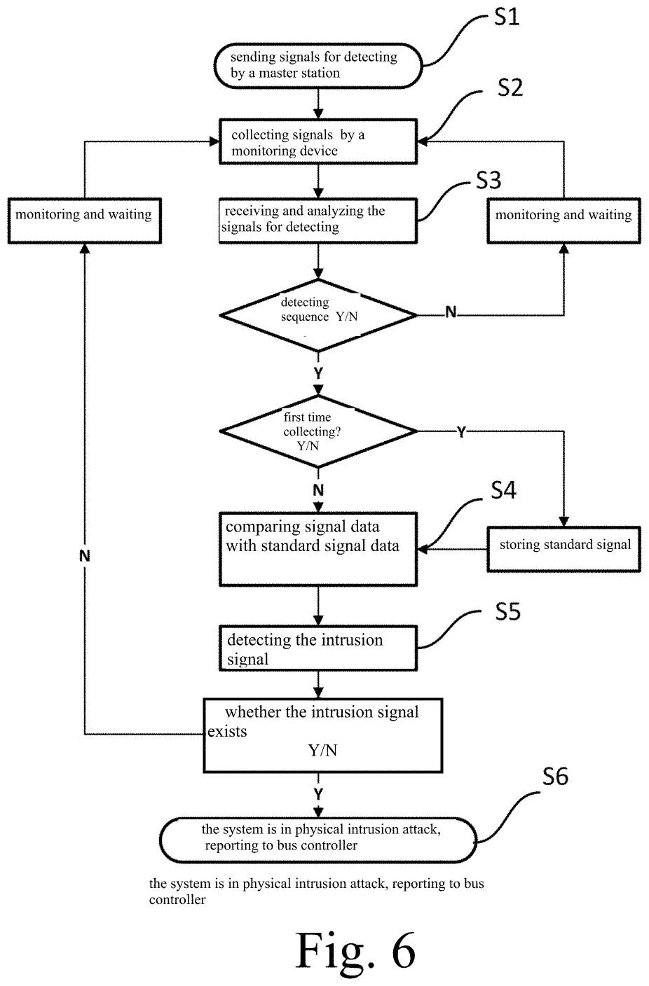

Step S501: performing noise reduction processing on the difference signal data; in the embodiment, using the digital averaging method to improve the SNR of the difference signal, and using MATLAB software to simulate the difference signal noise reduction processing. FIG. 4 is a noise reduction result of digital averaging method from a difference signal, and it can be seen from the figure that the digital averaging method can effectively reduce the influence of environmental noise and measurement noise on the difference signal;

Step S502: detecting whether the intrusion signal exists in the difference signal; the detection method in the embodiment uses the cross-correlation detection technology, and uses the MATALB software to perform the intrusion detection simulation on the difference signal. FIG. 5 shows the cross-correlation detection result from the difference signal and it can be seen from the figure that the cross-correlation detection technology can clearly distinguish the whether the intrusion signal exists in the difference signal to make a judgment for the physical intrusion attack of the system;

If the intrusion signal is detected in the difference signal, it is determined that the RS485 communication bus network has been subjected to a physical intrusion attack and continues to execute S6; if the intrusion signal is not detected in the difference signal, it is determined that the RS485 communication bus network is not subjected to a physical intrusion attack. The monitoring device turns to continue to monitoring state, and ends the processing of detecting the physical intrusion attack;

Step S6: According to the detection result of the intrusion signal, if the RS485 communication bus network is subjected to a physical intrusion attack, the detection result is reported to the RS485 controller, so that the controller can quickly judge and respond to the physical intrusion attack.

It can be seen from the above that by using the method for detecting physical intrusion attack proposed by the present invention, it is possible to quickly and accurately determine whether an external device exists in the system in the RS485 communication bus network, and determine that the system is subject to physical intrusion attacks.

One skilled in the art will understand that the embodiment of the present invention as shown in the drawings and described above is exemplary only and not intended to be limiting.

It will thus be seen that the objects of the present invention have been fully and effectively accomplished. Its embodiments has been shown and described for the purposes of illustrating the functional and structural principles of the present invention and is subject to change without departure from such principles. Therefore, this invention includes all modifications encompassed within the spirit and scope of the following claims.

What is claimed is:

1. A method for detecting physical intrusion attack in industrial control system based on analysis of signals on serial communication bus, comprising steps of: actively sending signals for detecting to a communication bus via a bus controller in a serial communication bus network, sampling and analyzing the signals on the communication bus by a monitoring device, performing differential comparison with a standard signal stored in the monitoring device database, detecting an intrusion signal in a difference signal by noise reduction technology and weak signal detection technology, and according to a detection result of the intrusion signal caused by an external device, effectively determining whether there is an external malicious device in the system, and determining whether the system is subjected to a physical intrusion attack.

2. The method for detecting physical intrusion attack in the industrial control system based on analysis of signals on serial communication bus, as recited in claim 1, specifically comprising steps of:
S1: monitoring a service condition of a serial communication bus in the industrial control system according to a set time period by the bus controller;
if the communication bus is in an idle state, sending a detection signal once by the bus controller;
if the communication bus is in a data transmission state, continuing to monitor and wait until the communication bus is in an idle state, and sending the detection signal once by the bus controller;
S2: performing sampling, receiving and protocol analysis on all communication signals on the serial communication bus by the monitoring device deployed in the network;
S3: analyzing signals after parsing and determine whether to start detecting physical intrusion attack in the industrial control system;
S4: comparing signal data received with standard signal data in the database of monitoring device to obtain a difference signal therebetween;
S5: detecting the intrusion signal on the difference signal; if the intrusion signal is detected in the difference signal, judging that the serial communication bus network of the industrial control system is subjected to the physical intrusion attack and continuing to execute S6; if no intrusion signal is detected in the difference signal, judging that the serial communication bus network of the industrial control system is not subjected to the physical intrusion attack and continuing to monitor the bus to receive a next communication signal;
S6: according to a detection result of the intrusion signal, if the serial communication bus network of the industrial communication system is subjected to physical intrusion attack, reporting the detection result to the bus controller in the serial communication bus network, and making a quick judgment and an emergency response on the physical intrusion attack by the bus controller.

3. The method for detecting physical intrusion attack in the industrial control system based on analysis of signals on serial communication bus, as recited in claim 1, wherein in the step S1, the detection signal is set according to a protocol specification of the serial communication bus, and the detection signal is different from all normal communication signals in the digital sequence, and the detection signal is only capable of being identified and analyzed by a corresponding monitoring device in the serial communication bus network, and the other devices are not capable of responding to detection signals.

4. The method for detecting physical intrusion attack in the industrial control system based on analysis of signals on serial communication bus, as recited in claim 1, wherein the step S2 specifically comprises steps of: according to types of the serial communication bus in the industrial control system, performing protocol parsing on corresponding communication signals by adopting one corresponding protocol such as Modbus, CANBus, P-Net, ProfiBus, WorldFIP, ControlNet, FF or HART to obtain a digital signal sequence.

5. The method for detecting physical intrusion attack in the industrial control system based on analysis of signals on serial communication bus, as recited in claim 1, wherein the step S3 specifically comprises steps of:
S301: performing consistency detection on the digital signal sequence parsed in the step S2 and the digital sequence of the detection signal, if the signal received is the detection signal, starting detecting the physical intrusion attack in the industrial control system, and performing a step S302; if the signal received is not a detection signal, then making no response, and continuing monitoring the bus to receive the next communication signal;
S302: according to a consistency detection result between the signal received and the detection signal, continuing to determine whether the monitoring device receives the detection signal for a first time; if the signal database of the monitoring device is empty, storing the received signal data in the local database, and considering the signal is a standard signal under normal conditions of the system; if the signal data is already stored in the signal database of the monitoring device, continuing performing the step S4.

6. The method for detecting physical intrusion attack in the industrial control system based on analysis of signals on serial communication bus, as recited in claim 1, wherein in the step S5, the intrusion signal is a definite signal added to an original detection signal sent by the bus controller caused by the physical intrusion attack, and the intrusion signal has the same period with the detection signal.

7. The method for detecting physical intrusion attack in the industrial control system based on analysis of signals on serial communication bus, as recited in claim 1, wherein the step S5 specifically comprises steps of:
S501: performing noise reduction processing on the difference signal data obtained in step S4;
S502: by a weak signal detection technology, detecting and determining whether the intrusion signal exists in the difference signal according to a result of the weak signal detection

8. The method for detecting physical intrusion attack in the industrial control system based on analysis of signals on serial communication bus, as recited in claim 1, further comprising a step of: alerting a master station after receiving the detection signal of the physical intrusion attack by the bus controller.
